(19) United States
(12) Patent Application Publication
(10) Pub. No.: US 2025/0159777 A1
(43) Pub. Date: May 15, 2025

(54) INTEGRATED ILLUMINATION MODULE, MONITORING ARRANGEMENT AND METHOD OF OPERATING A MONITORING ARRANGEMENT

(71) Applicant: ams Sensors Germany GMBH, Jena (DE)

(72) Inventor: Ho Hoai Duc NGUYEN, Munich (DE)

(21) Appl. No.: 18/839,998

(22) PCT Filed: Nov. 24, 2022
(86) PCT No.: PCT/EP2022/083075

§ 371 Date: Aug. 20, 2024

(30) Foreign Application Priority Data
Feb. 21, 2022 (DE) 10 2022 201 738.2

(51) Int. Cl. H05B 47/115; B60Q 3/76; B60Q 3/80; H05B 45/10; H05B 47/155

(52) U.S. Cl. CPC H05B 47/115; B60Q 3/76; B60Q 3/80; H05B 45/10; H05B 47/155; B60Q 2500/30

(57) ABSTRACT

An integrated illumination module for in-cabin monitoring, comprises a substrate and an active area comprising an array of pixels, wherein at least some pixels of the array are arranged in segments configured to provide illumination to a zone of a cabin, respectively. A driver circuit comprises an input to receive an occupancy signal indicative of an in-cabin presence and the driver circuit is operable to selectively drive pixels and adjust illumination to a zone of the cabin depending on the received occupancy signal, respectively.

This disclosure relates to an integrated illumination module, e.g. for in-cabin monitoring. Furthermore, the disclosure relates to a monitoring arrangement and method of operating a monitoring arrangement.

### BACKGROUND OF THE DISCLOSURE

The interior of vehicles (cabin) become increasingly crowded with sensors of various types. The sensors include optical sensors such as image sensors for object detection, driver monitoring, gesture recognition and other similar user interface functions, for example. Other optical sensors include proximity sensor, time-of-flight, LiDAR, ambient light, color sensor, and others. However, also non-optical sensors are implemented. Illumination can be employed to enhance performance and functionality of in-cabin sensors. In addition to adding low light and nighttime capabilities, the illumination can be used to highlight regions of interest and enable filtering out the ambient lighted background for the benefit of improved detectability and data processing. For example, near infrared (NIR) illumination may provide a condition where sensors are neither saturated due to bright day light or hardly detecting useful data due to dim lighting at night.

Illumination can be provided by dedicated light sources in the cabin of a vehicle. However, those devices cannot typically be combined with device which are already present in the cabin, such as headlights or other light sources. Furthermore, often there is no active feedback, which allows to determine or consider a state of occupancy in the cabin. Instead, the illumination may be constant over a fixed field-of-view, e.g. the entire cabin of the vehicle. Thus, known systems lack configurability and put demands on both space and power requirements.

It is an object of the present disclosure to provide an integrated illumination module for in-cabin monitoring, a monitoring arrangement and a method of operating a monitoring arrangement with improved configurability combined with fewer space and power requirements.

These objectives are achieved by the subject-matter of the independent claims. Further developments and embodiments are described in the dependent claims.

It is to be understood that any feature described in relation to any one embodiment may be used alone, or in combination with other features described herein, and may also be used in combination with one or more features of any other of the embodiments, or any combination of any other of the embodiments unless described as an alternative. Furthermore, equivalents and modifications not described below may also be employed without departing from the scope of the integrated illumination module, monitoring arrangement and method of operating a monitoring arrangement, which are defined in the accompanying claims.

### SUMMARY OF THE DISCLOSURE

The following relates to an improved concept in the field of illumination, e.g. illumination for signaling and sensing. The proposed concept suggests to integrate an active area comprising an array of pixels into a common module, and drive pixels in segments to provide illumination zones of a cabin, respectively. A driver circuit may receive one or more occupancy signals which provide control over the illuminated zones. The occupancy signals are indicative of an in-cabin presence.

In at least one embodiment an integrated illumination module for in-cabin monitoring comprises a substrate, an active area and a driver circuit. The active area comprises an array of pixels, wherein at least some pixels of the array are arranged in segments configured to provide illumination to a zone of a cabin, respectively. The driver circuit comprises an input to receive an occupancy signal indicative of an in-cabin presence. The driver circuit is operable to selectively drive pixels and adjust illumination to a zone of a cabin depending on the received occupancy signal, respectively.

In operation, the module receives via its input an occupancy signal of some sort, either from sensor internal or external to the module. In turn, the driver selects pixels which allow to illuminate a zone of the cabin which is occupied by a passenger, for example. Other zones may be illuminated less or not at all. This can be achieved by the same driver circuit, which depending on the received occupancy signal may drive pixels from corresponding segments so as to reduce illumination or switch off completely.

The integrated illumination module requires only a small footprint due to its high level of integration. Furthermore, the module can also be combined with existing devices, such as a headlamp or other source of in-cabin illumination. The module allows to consider various inputs, such as the occupancy signal(s), which leads to a high degree of configurability. For example, illumination can be adjusted or focused on only zone of the cabin which are occupied or needed to operate a respective in-cabin sensor. In fact, the module allows for separately controlling illumination levels of pixels or segments directed at different regions or zones of the cabin to provide adjustable illumination to the separate zones.

For example, the substrate can be a silicon substrate, e.g., a silicon wafer or a diced chip of a silicon wafer. The display substrate can also be of a different material such as FR4 or polyimide. For example, it is possible to grow InGaN-based LEDs and micro-LEDs directly on Sapphire and transfer them afterwards. The substrate may further comprise functional layers having circuitry for operating the pixels, such as components of a readout circuit and/or a driving circuit, for instance.

The pixels may be considered semiconductor light emitting devices. For example, the pixels are integrated on or into the substrate and/or the driver circuit. The term “active area” denotes that by means of the array of pixels said portion of the area is capable of emitting and/or sensing light which is incident on the active area.

A zone in the cabin can be considered any area or section of the cabin, e.g. and area where the driver, co-driver or any passenger is seated. The zones may be determined in view of the sensor which are used together with the module. For example, an optical sensor typically has a field of view. The corresponding zone may be chosen so that there is an overlap between zone and field of view.

In at least one embodiment the pixels of a segment are commonly operated to illuminate the zone of the cabin.

The driver circuit may operate the pixels individually. For example, the driver circuit provides a driving current to any given pixel, and thereby adjust its brightness, for example. However, a segment of pixels may comprise a plurality of pixels which are commonly driven by the driver circuit. This way there are segments dedicated to a respective zone to provide individual illumination to said zone. However, this may not exclude that a pixel may not be assigned to a segment at all time. For example, a segment may comprise a number of pixels at one time and a different number of pixels at another time. Thus, illumination may also be adjusted by the number of pixels assigned to a segment. Furthermore, choosing the number of pixels per segment also allows for improved beam shaping.

In addition, or alternatively, pixels of a segment are of the same type or at least some pixels are of a different type. Emitting wavelength of segments could differ, e.g. 850 nm and 940 nm, to avoid crosstalk.

In at least one embodiment the module further comprises an interface to receive at least one input signal from an external sensor to form the occupancy signal. For example, the external sensor may be an optical sensor or a non-optical sensor. The external sensor may input the occupancy signal via a dedicated input interface.

Possible sensor include, for example:
a sensor, such as a camera, to monitor a direction of the driver,
a vital sign sensor,
a security sensor, e.g. indicating whether a security belt is on or whether hands are on the steering wheel,
a sensor monitoring whether the driver pays attention, or backseat warning for strange behavior,
a sensor, such as a pressure sensor, monitoring of back seat presence,
a sensor, such as a pressure sensor, monitoring of co-driver (presence),
a sensor, such as the Airbag indicator, to detect whether children are co-driver (Airbag),
a sensor, such as a camera, for gesture detection, e.g. for every beam or reading lips and translating into commands, maybe with gesture
additional camera for sensor fusion and additional functionality,
Face recognition (LiDAR or camera),
feedback of seat adjustment for passengers,

The module may also be configured for authentication without key or authentication of all registered persons with restrictions. For example, the module may define a zone such that a beam is directed outside for authentication and unlocking the car. Authentication may depend on face for outside monitor for accessing the car The occupancy signal may be used for feedback with the vehicle engine, e.g. to limit the speed depending on persons. The feedback may also trigger other sensor, e.g. to open garage and house doors depending on authentication within the car, or other outside sensors.

In at least one embodiment a transceiver circuit comprises the driver circuit and is operable to selectively drive pixels in a first mode of operation or in a second mode of operation. In the first mode of operation the transceiver circuit is operable to drive pixels with a forward bias so as to emit light. In the second mode of operation, the transceiver circuit is operable to drive pixels with a reverse bias so as to detect light and generate an input signal from an internal sensor to form the occupancy signal.

The driver circuit can be complemented with detector circuitry to result in the transceiver circuit. The pixels can be altered in their functionality by means of a bias applied to them. The bias is provided by means of the transceiver circuit. The transceiver circuit is electrically connected to the array of pixels. For example, the transceiver circuit is configured to address the display pixels individually. Thus, the transceiver operates as a driver circuit of pixels. By way of the electrical connections the transceiver circuit provides a bias to the pixels. Which bias is applied to the pixels is defined according to the mode of operation of the module. Depending on the mode of operation pixels can be operated as light detector or emitter. Whether a pixel operates as detector or emitter depends on the bias it receives from the transceiver circuit. For example, reverse biasing allows for efficient photo detection using the Stark Effect or Quantum-Confined Stark-Effect. This way, a pixel can absorb visible or IR light. Thus, the transceiver operates as a detection circuit of pixels.

The transceiver circuit allows to operate the array of pixel, or parts thereof, such as the segments, with a light emitting or with a sensing functionality. This means that the same device can be employed as emitter and receiver, thus forming an electro-optical transceiver. Consequently, sensing functionality and illumination can be included into the module without requiring an additional sensor chip. Basically, the module acts as a transceiver, driven by the transceiver circuit. No additional optical components are required. The circuitry to inverse the polarity of the pixels in order to make them optical sensors may be comprised by the drive electronics, i.e. the transceiver circuit.

In at least one embodiment the array is directly integrated on the driver circuit or the substrate. The term “directly integrated” denotes that the driver circuit DC and/or the substrate SB form an integrated circuit with the pixels, or array.

In at least one embodiment, the driver circuit is operable to adjust at least one control parameter which affects illumination to a zone of the cabin by means of pixels of a respective segment. The control parameter comprises a repetition rate of said pixels, switching said pixels on or off and/or sets power irradiated into a respective zone by means of said pixels. Furthermore, the control parameter may also account for how many and which pixels are allocated to a respective segment.

In at least one embodiment the pixels comprise light-emitting diodes, micro light-emitting diodes and/or resonant cavity light-emitting devices.

LEDs and microscopic LEDs, or micro-LEDs for short, are based on conventional technology, e.g., for forming gallium nitride based LED. However, micro-LEDs are characterized by a much smaller footprint. Each micro-LED can be as small as 5 micrometers in size, for example. Micro-LEDs enable higher pixel density or a lower population density of active components, while maintaining a specific pixel brightness or luminosity. The latter aspect allows for the placement of additional active components in the pixel layer of the display, thus allowing for additional functionality and/or a more compact design. Micro-LEDs offer an enhanced energy efficiency compared to conventional LEDs by featuring a significantly higher brightness of the emission compared to other LEDs.

A resonant-cavity light emitting device can be considered a semiconductor device, similar to a light-emitting diode, which is operable to emit light based on a resonance process. In this process, the resonant-cavity light emitting device may directly convert electrical energy into light, e.g., when pumped directly with an electrical current to create amplified spontaneous emission. However, instead of producing stimulated emission only spontaneous emission may result, e.g., spontaneous emission perpendicular to a surface of the semiconductor is amplified. A resonant photodetector is established when reverse biasing a resonant light emitting device, such as a VCSEL or resonant cavity LED, for instance.

In at least one embodiment the module further comprises a plurality of optical elements. Each optical element is respectively arranged to cover a segment of pixels. Furthermore, each optical element is respectively configured to define a field of view of a respective illumination beam emitted from the pixels of the corresponding segment. The optical elements can be integrated or etched directly on the pixels, or array. Thus, the optics can be considered integral part of the integrated illumination module.

In at least one embodiment the optical element comprises a micro-lens and/or diffusors. The optical elements may comprise diffractive, refractive and/or holographic diffusors.

An example of an (refractive) optical element diffuser is a lens placed over a pixel or a segment. If the emitted light from the segment is a collimated beam, a negative lens can be used to turn the collimated beam into a divergent beam. Alternatively, a positive lens with a focal point which is much shorter than the distance to the illuminated target can be used. A larger diffusing angle, also referred to as a larger field of view, can be achieved using a stronger lens. A segment of pixels can be covered by an array of lenses, with one lens per pixel, or alternatively a single refractive lens can be used to cover the pixels of the whole segment. Alternatively, an array of prisms or other refractive optical elements can be used to diffract the light. The same optical function can be achieved with a micro-structured meta-surface or array of micro-lenses.

Examples of diffractive optical elements are a grating, or a small opening in an opaque screen. A smaller opening will create a larger amount of diffraction, or varying the grating constant will vary the amount of diffraction accordingly. An array of small openings can be used to create a speckle pattern based on interference between the light emerging from the openings. Holographic diffusers can be manufactured with photopolymers, and provide a further option for implementing the invention. Holographic diffusers may provide more precise control over the shape of the output beam and may thus help to homogenize the output beam to reduce a risk of hot spots compared to diffractive and/or refractive diffusers. A holographic diffuser may comprise one or more photopolymer layers comprising pseudo random, non-periodic structures, for example micro-lenses configured to provide a predetermined output field of view.

In at least one embodiment the fields of view associated to the segments provided by the plurality of optical elements are at least partially overlapping or are non-overlapping. Furthermore, the fields of view associated to the segments may overlap with respective fields of view of external sensor arranged in the cabin, i.e. the module is configured to illuminate a FOV of an external sensor, e.g. for improved detection.

In at least one embodiment the pixels of at least one segment emit light having an emission wavelength different from an emission wavelength of pixels of at least one other segment. This may further reduce optical crosstalk.

In at least one embodiment a monitoring arrangement comprises an integrated illumination module according to one or more of the aspects discussed above. Furthermore, the arrangement comprises at least one sensor. The module may be configured to illuminate a field of view of the sensor. The sensor is operable to provide to the module the occupancy signal so that illumination can be adjusted depending on the occupancy signal. There may be one or more sensor in the cabin and communicatively connected to the module in order to receive the occupancy signal(s).

In at least one embodiment the sensor is arranged in the cabin.

In at least one embodiment the array comprises the sensor. In this embodiment the module can be considered an internal sensor, i.e. the module by way of the array and transceiver circuit has sensing functionality, e.g. proximity or LiDAR detection.

In at least one embodiment a method of operating a monitoring arrangement comprises the steps of:
initializing the integrated illumination module,
turning on segments and generating an occupancy signal by means of at least one sensor and receiving the occupancy signal from the at least one sensor,
determining a state of occupancy, and
depending on the determined state of occupancy, illuminate only those zones which correspond to respective segments of the module, by selectively driving pixels and adjust illumination to said zone of the cabin depending on the state of occupancy, respectively.

For example, the integrated illumination module is initialized (e.g., when a vehicle starts). Then, the segments (e.g., all segments) are turned on and an occupancy signal is generated by and received from the at least one sensor. In a next step occupancy is determined. In a next step, depending on the occupancy, only those zones are illuminated which correspond to respective segments of the module, e.g., unneeded segments are turned off, or are reduced in illumination intensity.

The sequence of steps can be looped for dynamic scanning. The looping may stop, when the vehicle stops and the method may resume, once the vehicle is started again. Instead of switching off a repetition rate of emitters can be decreased if no passenger is present in a particular area.

The proposed integrated illumination module allows for dynamic adjusting of in-cabin illumination. For example, all segments are turned on for cabin scan. Afterwards, some arrays could be switched off depending on the passengers on the car. For example, only the driver is illuminated if there are no further passengers in the cabin. The Illumination field can dynamically controlled during the journey, i.e. once there is a change in occupancy the integrated illumination module can account for that presence.

Further embodiments of the lighting and monitoring arrangement according to the improved concept become apparent to a person skilled in the art from the embodiments of the integrated illumination module described above and vice versa.

Furthermore, as discussed above, the driver circuit can be complemented to a transceiver circuit. This allows to combine zone illumination and sensing functionality. This following aspects can be gained by implementing the driver circuit as transceiver circuit.

The following description of figures of example embodiments may further illustrate and explain aspects of the improved concept. Components and parts with the same structure and the same effect, respectively, appear with equivalent reference symbols. Insofar as components and parts correspond to one another in terms of their function in different figures, the description thereof is not necessarily repeated for each of the following figures. Thus, further embodiments of the integrated illumination module and lighting and monitoring arrangement according to the improved concept become apparent to a person skilled in the art from the aspects described below and vice versa.

According to an aspect, an integrated transceiver module for forward lighting, dynamic signaling and sensing comprises:
a substrate,
an active area comprising an array of pixels,
a transceiver circuit operable to selectively drive pixels in a first mode of operation or in a second mode of operation; wherein:
in the first mode of operation, the transceiver circuit is operable to drive pixels with a forward bias so as to emit light, and
in the second mode of operation, the transceiver circuit is operable to drive pixels with a reverse bias so as to detect light.

According to another aspect, the transceiver circuit (TC) is operable to address pixels individually by means of a select signal, and the pixels comprise in-pixel circuitry which is operable to selectively provide the forward bias or the reverse bias depending on the select signal.

According to another aspect, a processing unit is integrated into the module.

According to another aspect, the transceiver circuit is operable to address pixels:
to form a first subset of pixels commonly operated as light emitters in the first mode of operation, or
to form a second subset of pixels commonly operated as light detectors in the second mode of operation.

According to another aspect,
the first subset of pixels form one or more light emitting segments on the active area, and/or
the second subset of pixels form one or more light detecting segments on the active area.

According to another aspect,
in a LiDAR mode of operation, the first subset forms an emitter segment and the second subset forms a detector segment, spaced apart from the emitter segment,
the transceiver circuit is operable to drive pixels from the emitter segment to emit pulses of light, and
the transceiver circuit is operable to drive pixels from the detector segment to detect incident light synchronized with the emission of pulses of light.

According to another aspect, the processing unit is operable to determine a time-of-flight of emitted pulses of light and detected incident light.

According to another aspect,
in a structured light mode of operation, the first subset of pixels form a predefined pattern on the active area,
the transceiver circuit is operable to drive pixels from the pattern to emit pulses of light, and
the transceiver circuit is operable detect incident light by way of one or more of the light detecting segments and synchronized with the emission of pulses of light.

According to another aspect, the processing unit is operable to determine a detected pattern from light detected by the one or more of the light detecting segments.

According to another aspect, a third subset of pixels forms a lighting segment on the active area.

According to another aspect, the module comprises an array of micro-lenses, wherein micro-lenses of the array of micro-lenses are aligned with respective pixels of the array of pixels.

According to another aspect,
micro-lenses of the array of micro-lenses are aligned with one or more of the light emitting segments on the active display area, and/or
micro-lenses of the array of micro-lenses are aligned with one or more of the light detecting segments on the active display area.

According to another aspect, a lighting and monitoring arrangement comprises:
at least one integrated transceiver module according to an aspect above, and a host system comprising the module, wherein the host system comprises:
an illumination device for in-cabin illumination of a vehicle, or
an illumination device for exterior illumination of a vehicle.

According to another aspect, at least a first and a second module, wherein
the first and a second module are spaced apart, and the first and second module are operated in a combined LiDAR mode of operation; wherein:
a first subset of pixels form an emitter segment of the first module and a second subset of pixels form a detector segment of the second module,
a first transceiver circuit is operable to drive pixels from the emitter segment to emit pulses of light, and
a second transceiver circuit is operable to drive pixels from the detector segment to detect incident light synchronized with the emission of pulses of light.

### BRIEF DESCRIPTION OF THE DRAWINGS

In the Figures:

FIGS. 1A, 1B show example embodiments of integrated transceiver modules,

FIGS. 2A to 2D show example embodiments of in-pixel circuitry,

FIGS. 3A, 3B show further example embodiments of integrated transceiver modules,

FIGS. 4A, 4B show further example embodiments of integrated transceiver modules,

FIGS. 5A, 5B show further example embodiments of integrated transceiver modules,

FIG. 6 shows a further example embodiment of an integrated transceiver module,

FIGS. 7A, 7B show further show further example embodiments of lighting and monitoring arrangements,

FIGS. 8A to 8C show an example embodiment of an integrated illumination module, and

FIG. 9 shows an example flowchart of a method of operating an integrated illumination module.

### DETAILED DESCRIPTION

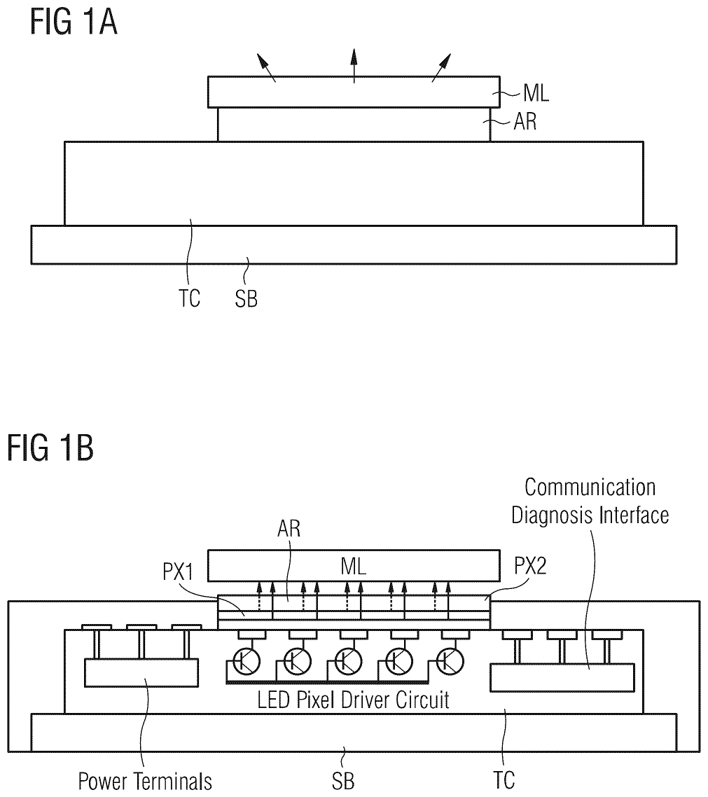

FIG. 1A shows an example embodiment of an integrated transceiver module. An integrated transceiver module comprises a substrate SB, an active area AR, a transceiver circuit TC and an array of micro-lenses ML. The module constitutes an integrated circuit with all its components integrated on the substrate or electrically connected thereto. For example, the module comprises a stack of substrate, active area, transceiver circuit and array of micro-lenses.

The active area AR comprises an array of pixels. Pixels are denoted light emitting devices. For example, pixels comprise light-emitting diodes, micro light-emitting diodes, laser diodes and/or resonant-cavity light emitting devices, such as VCSEL lasers. Typically, the active area comprises pixels of a same type, e.g. light-emitting diodes. However, the active area may also comprises pixels of a different type, e.g. light-emitting diodes and VCSELs. The pixels are integrated either on the transceiver circuit TC or in the substrate SB.

The array of micro-lenses ML comprises optical elements, such as micro-lenses, lenses and/or diffusers. For example, the micro-lenses are aligned with respective pixels of the array of pixels. Lenses and diffusers may be aligned with a number of pixels in order to determine a common field-of-view, for example. The optics could be monolithically grown on top of the pixels of the array or integrated/stacked on top of the module.

The transceiver circuit TC is integrated on the substrate SB. The transceiver circuit comprises circuitry to individually address pixels from the array. Pixels can be addressed by means of a select signal. Furthermore, the transceiver circuit comprises circuitry to selectively drive pixels in different modes of operation, or a combination or sequence of modes. The modes of operation are defined with respect to a bias which is provided to the respective pixels. The transceiver circuit addresses a pixels and provides either a forward bias or a reverse bias to the addressed pixel.

For example, in a first mode of operation, the transceiver circuit drives (or provides) pixels with a forward bias so as to emit light. In a second mode of operation, the transceiver circuit drives (or provides) pixels with a reverse bias so as to detect light. The pixels change their functionality depending on the bias applied to them. Depending on the mode of operation pixels can be operated as light detector or emitter. Whether a pixel operates as detector or emitter depends on the bias it receives from the transceiver circuit. For example, reverse biasing allows for efficient photo detection using the Stark Effect or Quantum-Confined Stark-Effect. This way, a pixel can absorb visible or IR light, for example. Thus, the transceiver operates as a detection circuit of pixels.

FIG. 1B shows an example embodiment of an integrated transceiver module. The drawing shows the module in greater detail. The transceiver circuit power terminals to receive driving current and a communication diagnosis interface for communication with further electronic components, such as a processing unit (external or integrated in the same module). Furthermore, the pixels comprise in-pixel circuitry which, as with the pixels, is integrated into the transceiver circuit. The in-pixel circuitry can be addressed by means of the select signal(s). Depending on the applied select signal the pixels receive either the forward bias (pixels PX1) or the reverse bias (pixels PX2).

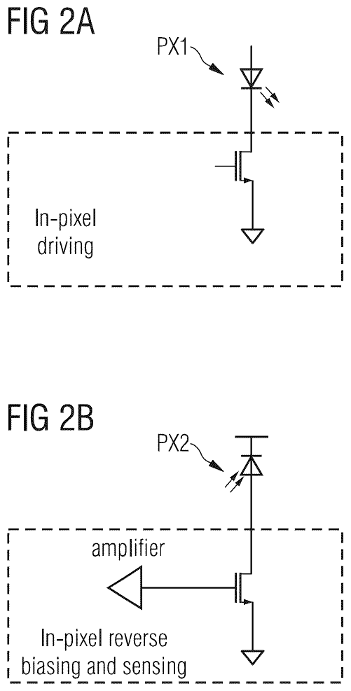

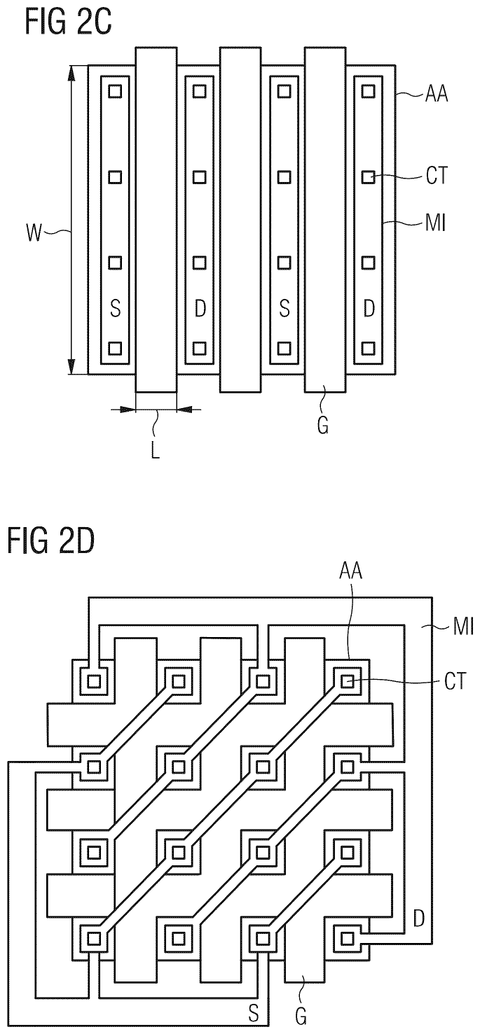

FIGS. 2A and 2B show example embodiments of in-pixel circuitry. The pixels of the array are arranged for light emission when they are provided with a forward bias Vbias, forward. However, if the same pixel is biased differently, e.g. reverse bias represented as Vbias, backward, the pixel is operable to detect light. The different bias conditions are provided to the pixels by inverting polarity of the bias current between Ibias, forward and Ibias, backward, as illustrated by the diode symbols in FIG. 2A (forward bias, PX1) and FIG. 2B (reverse bias, PX2).

The transceiver circuit TC is configured to alter the polarity of the bias current and provide this current to the pixels during the first and second mode of operation. Under first mode of operation, an LED junction is forward biased to emit light energy at various wavelengths that depend on the materials used. The reverse of this effect is that a standard LED emitting-junction can operate as a light-detecting junction, under second mode of operation, generating a photocurrent proportional to the incoming light energy. In the embodiment of FIGS. 2A and 2B the in-pixel circuitry comprises MOSFET transistors which along their drain and source terminals are connected to the pixel, e.g. light emitting diode. The gate may be coupled with respective control terminal to receive the select signals.

The layout of the pixels PX1, PX2 and in-pixel circuitry may be optimized with respect to the structures depicted in FIGS. 2C and 2D. FIG. 2C shows MOSFETs with rectangular shape of gate electrode with length of the channel L and width of the channel W. The drawing depicts an active area AA, polysilicon gate electrode G, contacts CT, metallic interconnection MI, source electrode S and drain electrode D. Basically, the MOSFETS are designed as stripes of width W and placed in parallel with length L. This layout effectively allows to reduce space requirements. FIG. 2D shows MOSFETS with a waffle structure. The drawing depicts an active area AA, polysilicon gate electrode G, contacts CT, metallic interconnection MI, source electrode S and drain electrode D. This alternative layout may reduce space requirements even further, theoretically down to 40% of substrate area.

The individual addressing of pixels by means of the transceiver circuit TC allows to form subsets of pixels. These subsets may form segments or contiguous areas on the array AR of pixels. The subsets may also form defined patterns on the array. Furthermore, the forming of segments and patterns can also change over the course of operation of the module. At any time a single pixel, or commonly those pixels associated with a respective segment or pattern, can be operating either as light emitters in the first mode of operation or operated as light detectors in the second mode of operation.

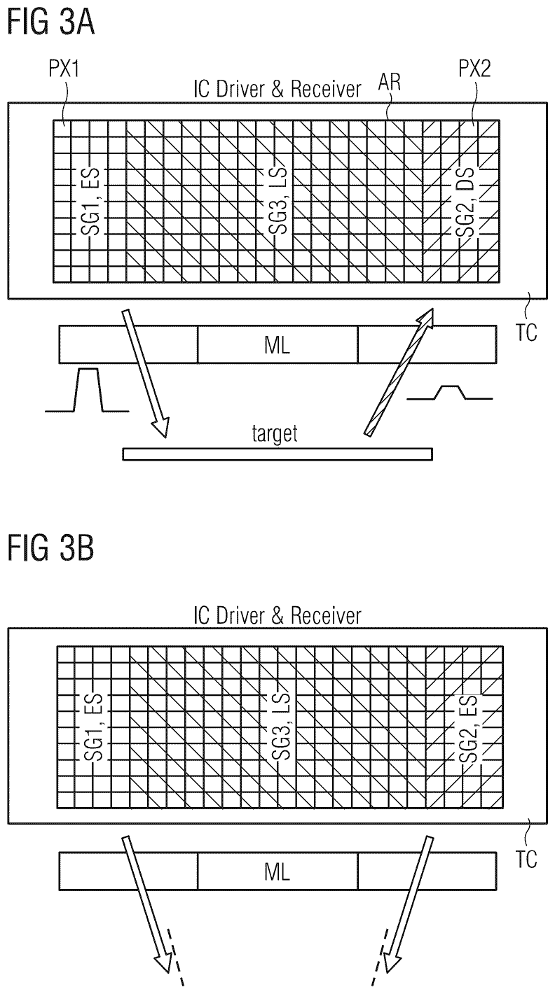

FIG. 3A shows a further example embodiment of an integrated transceiver module. The drawing shows the array of pixels in top view. Depicted are three segments SG1, SG2, SG3 which are formed by respective subsets of pixels. Whether a pixel belongs to a respective segment is not a question of a hardwired connection, or the like. Rather, the transceiver circuit TC addresses the pixels and thereby determines if said pixels are operated in the first or second mode of operation.

In this example, pixels are addressed to form a first subset of pixels and are commonly operated as light emitters in the first mode of operation. The first subset of pixels forms a light emitting segment ES on the active area AR. Similarly, pixels are addressed to form a second subset of pixels and are commonly operated as light detectors in the second mode of operation. The second subset of pixels forms a light detecting segment DS on the active area AR.

Furthermore, some pixels are addressed to form a third subset of pixels. The third subset forms a lighting segment LS on the active display area. This lighting segment may not alter its mode of operation and may be used for illumination, e.g. of parts of a cabin.

This embodiment can be used as a LiDAR detector. In a LiDAR mode of operation, the first subset forms an emitter segment and the second subset forms a detector segment. These segments correspond to the light emitting segment LS and light detecting segment DS and are spaced apart from each other to form a baseline. In order to implement the LiDAR functionality, the transceiver circuit TS further drives pixels from the emitter segment to emit pulses of light. Correspondingly, the transceiver circuit further drives pixels from the detector segment to detect incident light. Operation of the emitter segment and the detector segment is synchronized with the emission of pulses of light.

The module may optionally comprises a processing unit integrated into the module, such as a microcontroller or ASIC, which is integrated into the module as well. The processing unit determines a time-of-flight of emitted pulses of light, as starting event, and detected incident light, as stop event. The LiDAR mode of operation provides a method for determining ranges (such as variable distance) by targeting an external object with light pulses emitted by the pixels of the emitter segment. Measuring the time-of-flight provides a measure of distance of pulses reflected at the external object and being returned to the detector segment.

A field of view is illuminated with a wide diverging light in a single pulse, for example. The optics, such as micro-lens array ML, defines the field of view. For example, the optic can be arranged to illuminate a desired field of view, e.g. inside a cabin. This way, range measurement can be configured into a direction of interest, e.g. where a driver is located, or not (presence detection). Depth information is collected using the time-of-flight of the reflected pulse (i.e., the time it takes each emitted pulse to hit the target and return to the array), which requires the pulsing (emission by the emitter segment) and acquisition (detection by the detector segment) to be synchronized.

FIG. 3B shows a further example embodiment of an integrated transceiver module. The drawing shows the array of pixels in top view. Similar to FIG. 3A three segments are depicted which are formed by respective subsets of pixels, respectively.

In this example, pixels are addressed to form a first subset of pixels and are commonly operated as light emitters in the first mode of operation. The first subset of pixels forms a light emitting segment ES on the active area AR. Similarly, pixels are addressed to form a second subset of pixels and are commonly operated as light emitters in the first mode of operation. The second subset of pixels forms another light emitting segment ES on the active area. Furthermore, some pixels are addressed to form a third subset of pixels. The subsets basically form lighting segments LS on the active display area.

This embodiment can be used as a projector. In a projection mode of operation, one, two or all segments, can be operated to emit light, e.g. at the same time or in a sequence, or only when activated. The segments may be assigned to illuminate a certain direction only. The optics, e.g. micro-lens array, may also have segments which correspond to the respective lighting segments. This way a given lighting segment LS may be used to illuminate a dedicated field-of-view. The transceiver circuit TC then acts as a driver circuit which can address pixels to illuminate a desired direction of interest.

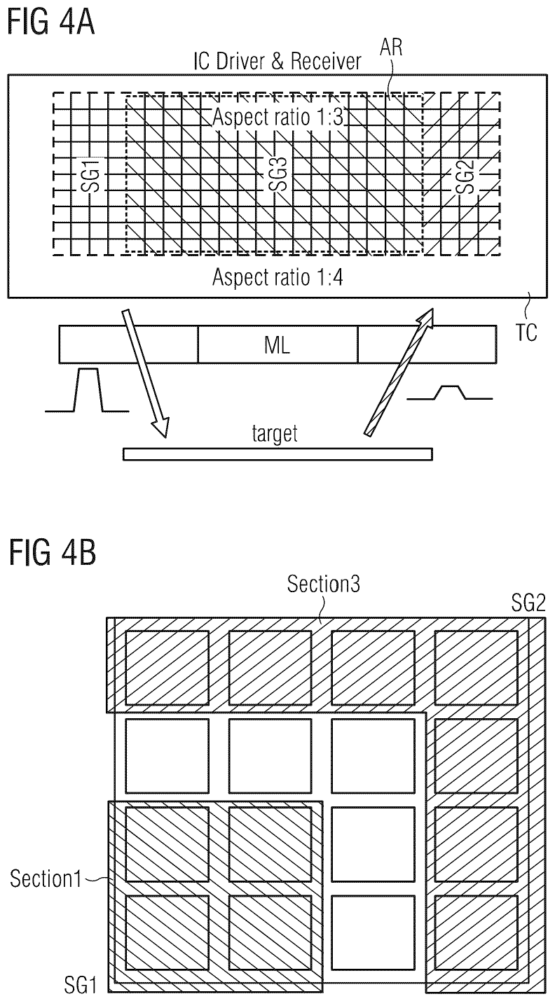

FIGS. 4A and 4B show further example embodiments of integrated transceiver modules. The transceiver circuit can alter the subsets, or allocate pixels to segments SG1 to SG3, simply by addressing pixels to be operated in the first or second mode of operation. This way the area or number of pixels allocated to a respective segment can be adjusted. For example, for the embodiments of FIG. 3A and 3B an aspect ratio of 1:3 or 1:4 may be defined, i.e. relative area of lighting segment with respect to emitter segment and/or detector segment. This way a large part of the module can be used for illumination and a smaller part of detection purpose, e.g. LiDAR. FIG. 4B depicts that the shape of segments can also be adjusted, or altered during operation.

A range of detection can be adjusted or extended depending on how much the emitter segment and the detector segment are spaced apart (baseline). The baseline can be determined by means of the transceiver circuit TC. The transceiver circuit can alter the subsets, or allocate pixels to segments, simply by addressing pixels to be operated in the first or second mode of operation. This way the emitter segment and the detector segment do not necessarily have to be fixed but may be spaced apart differently. By changing the distance between the segments, or baseline, different ranges can be detected.

Furthermore, in an embodiment not shown, the transceiver circuit TC may form more light emitting ES and/or light detecting segments DS. For example, more than one pair of emitter and detector segments can be formed, effectively forming LiDAR detector with several ranges in parallel.

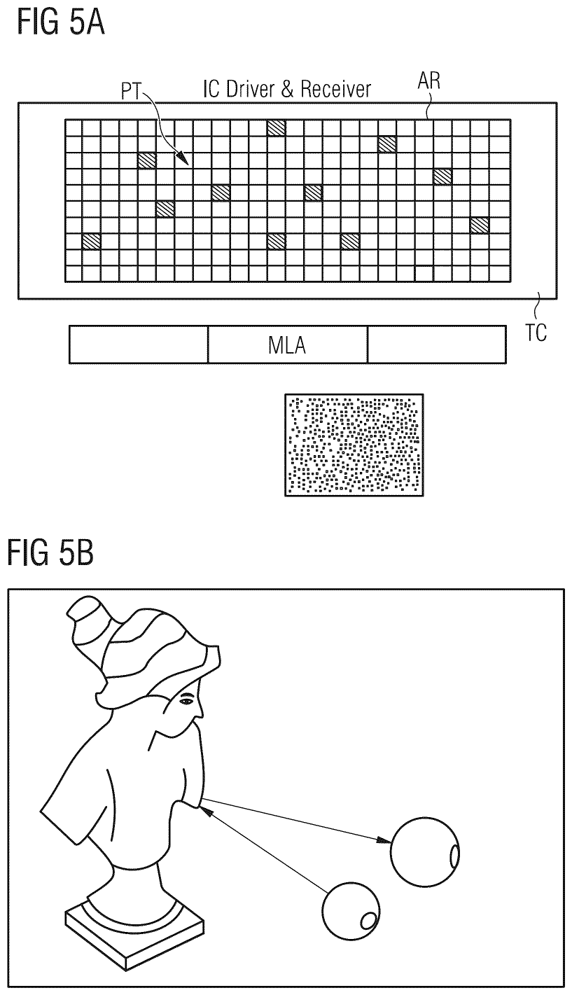

FIG. 5A shows a further example embodiment of an integrated transceiver module. The drawing shows the array of pixels in top view. Different to FIG. 3A, however, the first subset of pixels forms a pattern PT on the array.

For example, in a structured light mode of operation, the first subset of pixels form a predefined pattern on the active display area. The pixels of the pattern are operated as light emitters, i.e. in the first mode of operation. The transceiver circuit is operable to drive pixels from the pattern to emit pulses of light. Thus, the first subset of pixels may project the predefined or known pattern (e.g., grids or horizontal bars) onto an external scene (as indicated in FIG. 5B).

The way that these patterns deform when striking an external surface and eventually return to the module by way of reflection or scattering. The deformed pattern can be detected by the second subset of pixels. These pixels are operated by the transceiver circuit TC as light detectors, i.e. in the second mode of operation. Detection is synchronized with the emission of pulses of light. For example, the pixels are operated as detectors only after emission of pulses. Alternatively, the pixels are operated as detectors continuously.

The second subset of pixels generate detection signals which allow to construct the returned pattern. A deformation can be detected from light detected by the one or more of the light detecting segments. For example, vision systems (external or integrated into the module) allow to calculate depth and surface information of external objects in a scene.

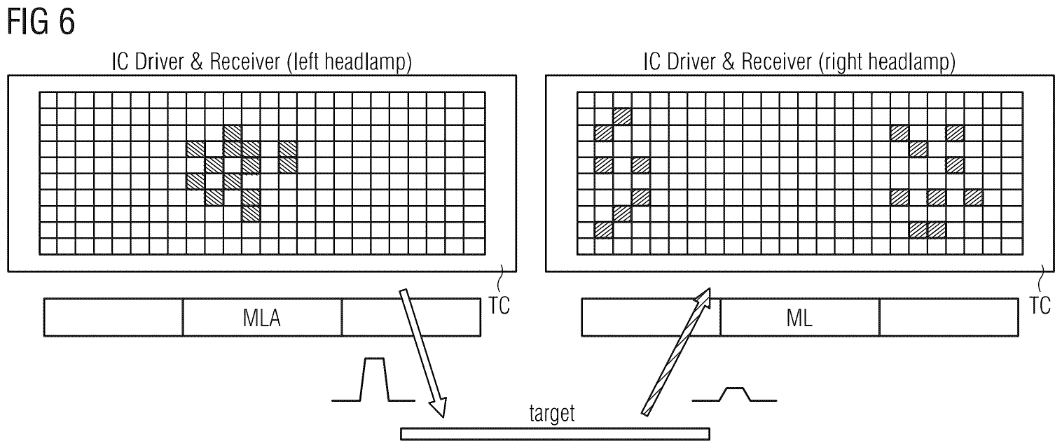

FIG. 6 shows an example embodiment of a lighting and monitoring arrangement. The sensing and emission functionality can be integrated into a single module. However, it is also possible to combine a pair of more modules in order to build a larger lighting and monitoring arrangement. For example, a first and a second module are spaced apart, e.g. by a baseline. The first and second module are operated in a combined LiDAR mode of operation, i.e. the first module serves as emitter and the second module serves as detector.

In the combined LiDAR mode of operation, a first subset of pixels of the first module M1 forms an emitter segment ES (or pattern PT) and a second subset of the second module M2 forms a detector segment DS (or pattern PT). The emitter and detector are spaced apart from each other to form a baseline. In order to implement the LiDAR functionality, the transceiver circuit of the first module drives pixels from the emitter to emit pulses of light. Correspondingly, the transceiver circuit TC of the second module drives pixels from the detector to detect incident light. Operation of the emitter and the detector segment is synchronized with the emission of pulses of light. For example, the transceiver circuits may be electrically or optically connected to establish synchronization.

The two modules can be integrated into a host system. For example, the modules can be arranged in an illumination device for in-cabin illumination of a vehicle, e.g. a left and right headlamp). The host system can also be an illumination device for exterior illumination of a vehicle, etc.

In general, the functionality and features discussed herein for a single module can be applied to any pair or larger number of modules. In fact, any specific functionality, such as driving pixels in a mode of operation may be shared between modules so as to complement each other to achieve a combined functionality. Synchronization may be supported by means of one or more processing units. These units may be integrated in the modules or may be an external component, e.g. a microprocessor of the host system.

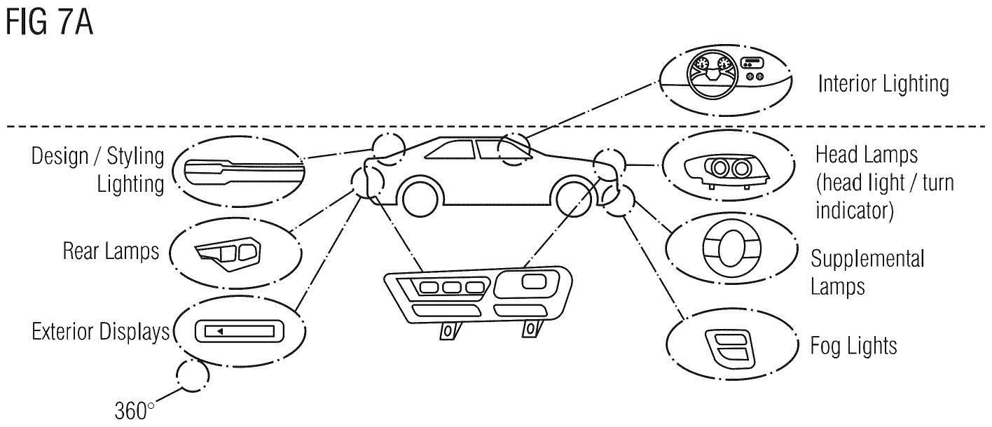

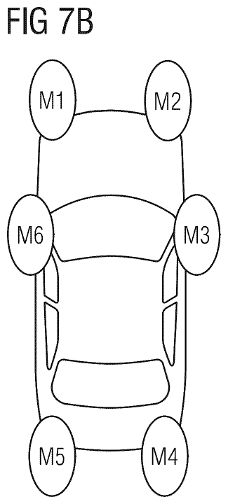

FIGS. 7A and 7B show further example embodiments of lighting and monitoring arrangements. There are as many possible applications as there are possible host systems. The module combine pixels to function as emitter and detector (e.g., photodiode reverse-biased LED, and light emitting diode forward-biased LED). Modules include monolithic integration of driver and detector circuit (transceiver circuit) and optics, such as micro-lens array. The modules allow for smart segmented layout for emitter and receiver arrays, both in a static or dynamic fashion. Possible applications include ranging, Lidar cocoon, proximity sensing and in-cabin sensing, to name but a few.

FIG. 7A shows possible host systems associated with a vehicle. These systems typically provide lighting inside or outside of the vehicle. Using the proposed module, however, the lighting can be complemented with sensing functionality. Examples include interior lighting, head lamps (e.g., head light, turn indicator), fog lights, exterior displays, rear and front lamps and design elements, etc. As one general guideline, the module can be used wherever there is a need for semiconductor light emitters. Then there may be light detectors as well.

FIG. 7B shows a LiDAR cocoon. The lighting and monitoring arrangement comprises a plurality of modules M1 to M6 which are arranged around a vehicle. Each one of the modules may be operated in the LiDAR mode of operation. However, pairs of modules can be assigned and operated in the combined LiDAR mode of operation. This way the lighting and monitoring arrangement can be used with various combinations, baselines and, thus, ranges.

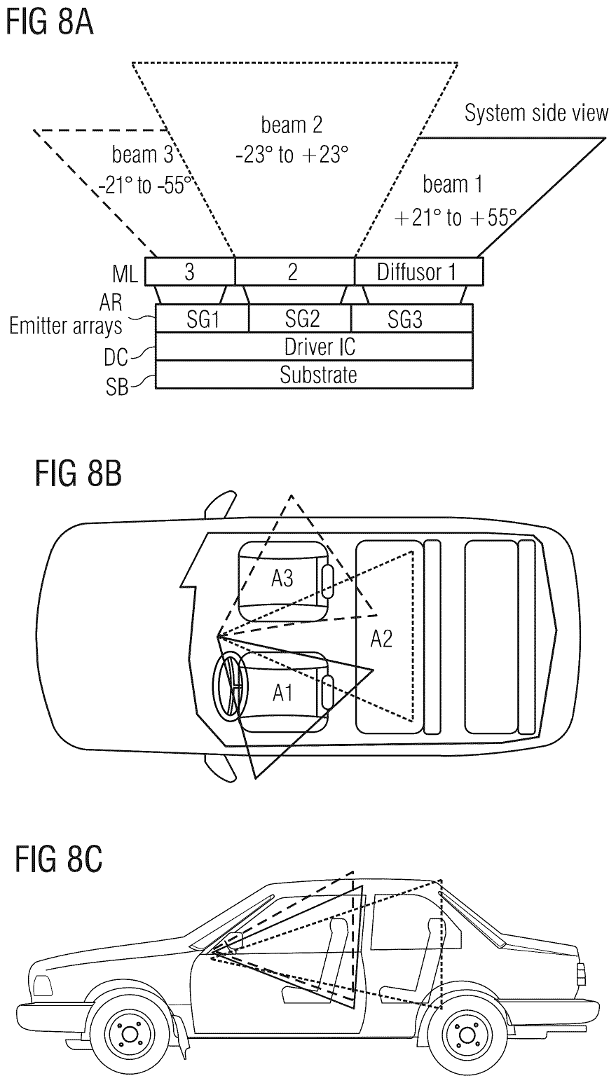

FIGS. 8A to 8C show an example embodiment of an integrated illumination module. The module comprises a substrate SB, an active area AR and a driver circuit DC. The drawing shows the module in side view.

The active area AR comprises an array of pixels. At least some pixels of the array are arranged in segments SG1, SG3, SG3 configured to provide illumination to a zone of a cabin, respectively. Pixels are denoted light emitting devices. For example, pixels comprise light-emitting diodes, micro light-emitting diodes, laser diodes and/or resonant-cavity light emitting devices. In this example embodiment the pixels comprises VCSEL lasers and are arranged to emit visual light.

Pixels which are arranged in a segment are commonly operated to illuminate the zone of the cabin, respectively. Typically, the active area AR comprises pixels of a same type, e.g. light-emitting diodes. However, the active area may also comprises pixels of a different type, e.g. light-emitting diodes and VCSELs. The pixels are integrated either on the driver circuit or in the substrate. In fact, the pixels, or array, is directly integrated on the driver circuit or the substrate, i.e. the driver circuit DC and/or the substrate SB form an integrated circuit with the pixels, or array.

The module further comprises a plurality of optical elements ML. Each optical element is arranged to cover a segment SG1, SG2, SG3 of pixels. The optical elements can be a diffuser or micro-lens, for example. Each optical element is respectively configured to define a field of view of a respective illumination beam which is emitted from the pixels of a corresponding segment. The field of views of the segments can be partially overlapping, as depicted in FIGS. 8B and 8C or are non-overlapping. Emission of pixel of a segment can be of different emission wavelength, or mixture of wavelengths, compared to neighboring segments. This allows to better distinguish segment emission, e.g. for the purpose of additional sensing functionality.

An example of an (refractive) optical element diffuser is a lens placed over a pixel or a segment. If the emitted light from the segment is a collimated beam, a negative lens can be used to turn the collimated beam into a divergent beam. Alternatively, a positive lens with a focal point which is much shorter than the distance to the illuminated target can be used. A larger diffusing angle, also referred to as a larger field of view, can be achieved using a stronger lens. A segment of pixels can be covered by an array of lenses, with one lens per pixel, or alternatively a single refractive lens can be used to cover the pixels of the whole segment. Alternatively, an array of prisms or other refractive optical elements can be used to diffract the light. The same optical function can be achieved with a micro-structured meta-surface or array of micro-lenses.

Examples of diffractive optical elements are a grating, or a small opening in an opaque screen. A smaller opening will create a larger amount of diffraction, or varying the grating constant will vary the amount of diffraction accordingly. An array of small openings can be used to create a speckle pattern based on interference between the light emerging from the openings. Holographic diffusers can be manufactured with photopolymers, and provide a further option for implementing the invention. Holographic diffusers may provide more precise control over the shape of the output beam and may thus help to homogenize the output beam to reduce a risk of hot spots compared to diffractive and/or refractive diffusers. A holographic diffuser may comprise one or more photopolymer layers comprising pseudo random, non-periodic structures, for example micro-lenses configured to provide a predetermined output field of view.

The optical elements ML, individual or array type, can be integrated or etched directly on the pixels, or array. Thus, the optics can be considered integral part of the integrated illumination module.

The drawing of FIG. 8A shows an example with three segments of pixels, or emitter arrays. A respective optical element ML is arranged to cover the segments, so that in operation by means of the driver circuit respective beams of light are directed into a cabin of a vehicle, for example. The beams illuminate respective areas in the cabin. For example, a field of illumination is split into three areas according to the segments formed on the module array. Size of these areas depends on the eye safety limit for passengers in the cabin, for example.

Each area A1 to A3 can serve a different field of illumination and/or additional sensing functionality in a cabin. For example, a first area serves the driver for driver illumination and monitoring, e.g. vital sign monitoring for high resolution, range: 1 m. A second area serves the rear-row passengers, range ˜2 m and a third area serves the co-drivers.

The additional sensing functionality can be achieved by complementing the driver circuit of the proposed integrated transceiver circuit. This way module constitutes a transceiver module for forward lighting, dynamic signaling and sensing as discussed above. All features and embodiments discussed above then apply to the integrated illumination module for in-cabin monitoring. The additional sensing functionality can also be achieved by one or more external sensor which are arranged inside or outside of the cabin. These sensor include any of proximity sensors, time-of-flight sensors, LiDAR sensors, occupancy sensor, vital sign sensors, seat belt sensor, camera, gesture sensor, and seat sensor, for example.

The driver circuit comprises an input to receive an occupancy signal. The occupancy signal indicates a presence or occupancy of a person in the cabin. By way of the input one or more occupancy signals can be received by the module. In turn, the driver circuit selectively drives pixels from the segments and adjust illumination to a zone of the cabin depending on the received occupancy signal, respectively. For example, only an area of the cabin is illuminated from which an occupancy signal was received, indicating that a person occupies said area.

This allows to save power needed to illuminate the cabin, as only the occupied area is illuminated, or other areas are not illuminated at all, or only with reduced intensity. For example, it can be shown that the segmented array can reduce total optical power needed by three to seven times. Emitting wavelength of segments could differ, e.g. 850 nm and 940 nm, to avoid crosstalk.

The input can be implemented as an interface for the external sensor(s). The input can also be an internal terminal which provides the signal generated by the “internal” sensor, i.e. the integrated transceiver module.

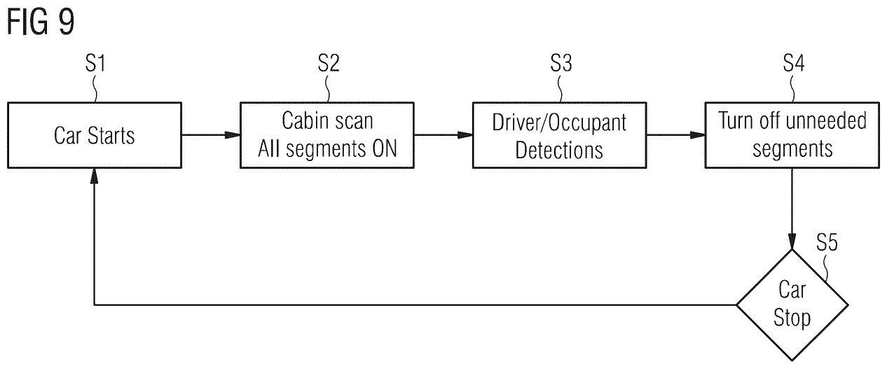

FIG. 9 shows an example flowchart of a method of operating an integrated illumination module. The proposed integrated illumination module allows for dynamic adjusting of in-cabin illumination. For example, all segments are turned on for cabin scan. Afterwards, some arrays could be switched off depending on the passengers on the car. For example, only the driver is illuminated if there are no further passengers in the cabin. The Illumination field can dynamically controlled during the journey, i.e. once there is a change in occupancy the integrated illumination module can account for that presence.

The drawing shows an example flow which can be executed when the vehicle stars (step S1). In step S2 all segments are turned on and occupancy signal from all involved sensor, internal or external, are “scanned”. In a next step occupancy is determined (step S3). Depending on the occupancy only those areas are illuminated which correspond to respective segments of the module. Unneeded segments are turned off, or are reduced in illumination intensity (step S4). The sequence of steps S2 to S4 can be looped for dynamic scanning. The looping may stop, when the vehicle stops (step S5) and the flow may return to step S1, once the vehicle is started again. Instead of switching off a repetition rate of emitters can be decreased if no passenger is present in a particular area.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

A number of implementations have been described. Nevertheless, various modifications may be made without departing from the spirit and scope of the invention. Accordingly, other implementations are within the scope of the claims.

For example, further aspects of the disclosure relate to or can be derived from the following.

The array may be segmented into segments or single pixels, such as VCSELs, i.e. some pixels may have a different functionality than illumination. The optics may comprise a mixture between refractive optics and diffusors, e.g. to shape beams for better reliability. Furthermore, certain areas of the cabin can illuminated with two or more segments, i.e. by overlapping FOV. The FOV can be adjusted for increased power saving.

The sensors, internal or external, may also monitor additional information, which affects illumination. For example, a sensor can be watching the direction of the driver so that illumination follows the driver. A monitor for vital sign monitoring can be implemented, e.g. vital sign, security belt, and hands on steering wheel. This way illumination may indicate to a passenger that a vital signal is critical or needs attention, or monitor if the driver pays attention.

Other monitoring includes a seatbelt closed monitor, children as co-driver detection (Airbag), gesture detection for every beam, additional camera for sensor fusion and additional functionality such as face recognition (LiDAR and camera) Reading lips and translating into commands, maybe with gesture. Backseat warning for strange behavior and seat adjustment for passengers can be included.

Further functionality can be complemented to illumination or combined with illumination, including authentication without key, authentication of all registered persons with restrictions, one beam directed outside the cabin for authentication and unlocking the car. Limit the speed depending on persons and open garage and house doors depending on authentication within the car. Outside sensors (maybe more for the outdoor application) can be added. Authentication may depend on face for outside monitor for accessing the car.

### Reference Numerals

A1 to A3 area of illumination
AA active area
AR array of pixels
CT contact
D drain electrode
DS detector segment
ES emitter segment
G gate electrode
L length of channel
LS lighting segment
M1 to M6 modules
MI metallic interconnection
ML micro-lens array
PT pattern
PX1 first subset of pixels
PX2 second subset of pixels
S source electrode
SB substrate
TC transceiver circuit
W width of the channel

1. An integrated illumination module for in-cabin monitoring, comprising:
a substrate,
an active area comprising an array of pixels, wherein at least some pixels of the array are arranged in segments configured to provide illumination to a zone of a cabin, respectively, and
a driver circuit comprising an input to receive an occupancy signal indicative of an in-cabin presence and the driver circuit is operable to selectively drive pixels and adjust illumination to a zone of the cabin depending on the received occupancy signal, respectively.

2. The module according to claim 1, wherein
pixels of a segment are commonly operated to illuminate the zone of the cabin, and/or
pixels of a segment are of same type or at least some pixels are of different type.

3. The module according to claim 1, further comprising an interface to receive at least one input signal from an external sensor to form the occupancy signal.

4. The module according to claim 1, wherein:
a transceiver circuit comprises the driver circuit and is operable to selectively drive pixels in a first mode of operation or in a second mode of operation; wherein:
in the first mode of operation, the transceiver circuit is operable to drive pixels with a forward bias so as to emit light, and
in the second mode of operation, the transceiver circuit is operable to drive pixels with a reverse bias so as to detect light and generate an input signal from as internal sensor to form the occupancy signal.

5. The module according to claim 1, wherein the array is directly integrated on the driver circuit or the substrate.

6. The module according to claim 1, wherein
the driver circuit is operable to adjust at least one control parameter which affects illumination to a zone of the cabin by means of pixels of a respective segment, and
the control parameter comprises a repetition rate of said pixels, switching said pixels on/off and/or sets power irradiated into a respective zone by means of said pixels.

7. The module according to claim 1, wherein the pixels comprise:
light-emitting diodes,
micro light-emitting diodes, and/or
resonant-cavity light emitting devices.

8. The module according to claim 1, further comprising a plurality of optical elements, each optical element is respectively arranged to cover a segment of pixels, and each optical element is respectively configured to define a field of view of a respective illumination beam emitted from the pixels of the corresponding segment.

9. The module according to claim 8, wherein the optical element comprises a micro-lens and/or diffusers, such as diffractive, refractive and/or holographic diffusers.

10. The module according to claim 8, wherein the field of views of the segments provided by the plurality of optical elements are at least partially overlapping or are non-overlapping.

11. The module according to claim 1, wherein pixels of at least one segment emit light having an emission wavelength different from an emission wavelength of pixels of at least one other segment.

12. A monitoring arrangement comprising:
an integrated illumination module according to claim 1, and
at least one sensor and operable to provide the occupancy signal.

13. The monitoring module according to claim 12, wherein the at least one sensor is arranged in the cabin.

14. The monitoring module according to claim 11, wherein the array comprises the at least one sensor.

15. A method of operating a monitoring module comprising an integrated illumination module with an active area comprising an array of pixels, wherein at least some pixels of the array are arranged in segments configured to provide illumination to a zone of a cabin, respectively, the method comprising the steps of:
initializing the integrated illumination module,
turning on segments and generating an occupancy signal by means of at least one sensor and receiving the occupancy signal from the at least one sensor,
determining a state of occupancy, and
depending on the determined state of occupancy, illuminate only those zones which correspond to respective segments of the module, by selectively driving pixels and adjust illumination to said zone of the cabin depending on the state of occupancy, respectively.
